(19) United States
(12) Patent Application Publication
(10) Pub. No.: US 2025/0088878 A1
(43) Pub. Date: Mar. 13, 2025

(54) METHOD FOR CONFIGURING A MOBILE COMMUNICATION TESTER

(71) Applicant: Rohde & Schwarz GmbH & Co. KG, Muenchen (DE)

(72) Inventors: Hanush KHURANA, Muenchen (DE); Maximilian SCHMAUTZ, Muenchen (DE); Rishi THEIVENDRAN, Kanata (CA)

(73) Assignee: Rohde & Schwarz GmbH & Co. KG, Muenchen (DE)

(21) Appl. No.: 18/466,366

(22) Filed: Sep. 13, 2023

(51) Int. Cl. H04W 24/08

(52) U.S. Cl. CPC H04W 24/08

(57) ABSTRACT

A method for configuring a mobile communication tester is described. The method comprises the steps of: providing a mobile communication tester with an electronic circuit configured for testing a device under test; receiving, by the electronic circuit, at least one configuration message that is formatted at least partially in ASN.1; processing, by the electronic circuit, the at least one configuration message formatted in ASN.1; and deriving, by the electronic circuit, a configuration setting of the mobile communication tester at least partly from the at least one configuration message received.

### FIELD OF THE DISCLOSURE

The present disclosure relates to mobile communication testers and particularly to methods for configuring mobile communication testers.

### BACKGROUND

Mobile communication testers are commonly used for testing wireless devices like for example smartphones or tablets. For example, the wireless communication functionality of a device can be tested. Mobile communication testers are also known under the designations wireless network emulator, signaling tester, or radio communication tester.

When configuring a (mobile communication) tester, user input typically undergoes a transformation before being saved or implemented as configuration settings of the mobile communication tester. For example, the user input is often transmitted via an application programming interface (API) of the mobile communication tester.

Hence, the user has to learn how to obtain a desired configuration of a mobile communication tester and how the user input is affected by the API of the mobile communication tester.

### SUMMARY

Methods and mobile communication testers according to embodiments of the present disclosure address the issues described above and/or others. Aspects and embodiments of the present disclosure are associated with an increased user-friendliness and/or an improved time-efficiency. In most instances, the amount of practice required before being able to configure the mobile communication tester can be reduced or even eliminated.

The present disclosure provides a method for configuring a mobile communication tester. In an embodiment, the method comprises the steps of: providing a mobile communication tester with an electronic circuit configured for testing a device under test; receiving, by the electronic circuit, at least one configuration message that is (at least partially) formatted in Abstract Syntax Notation One, ASN.1; processing, by the electronic circuit, the at least one configuration message formatted in ASN.1; and deriving, by the electronic circuit, a configuration setting of the mobile communication tester at least partly from the at least one configuration message received.

Consequently, at least a part of the configuration of the mobile communication tester may be based on the received configuration message. Hence, the user does not have to learn how an application programming interface (API) or a graphical user interface (GUI) of the mobile communication tester operates. In this way, the amount of configuration work can be reduced, for example, for users with knowledge of the ASN.1 notation. In contrast, known mobile communication testers do not use messages written in ASN.1 for configuring itself. In cases where an ASN.1 message is received, known testers may replay the message but it does not cause any alteration of the tester's configuration or even setting the configuration of the mobile communication tester by the ASN.1 message.

In some embodiments, the device under test (DUT) includes a user equipment (UE). In some embodiments, the electronic circuit is configured for testing signaling properties of the DUT. As an example, the DUT may be tested via 5G or 5G New Radio.

Abstract Syntax Notation One (ASN.1) is a joint standard of the International Telecommunication Union Telecommunication Standardization Sector (ITU-T) and ISO/IEC (see ITU-T Recommendations X.680-X.683). In the context of the present disclosure, a message being formatted in ASN.1 may be understood as the message being written in the notation ASN.1. In some embodiments, the configuration message may be formatted entirely in ASN.1.

In some embodiments, the method includes implementing the derived configuration setting in the mobile communication tester. In other words, the method, for example, includes configuring settings of the mobile communication tester at least partly according to the received configuration message. In some embodiments, the method includes configuring settings of the mobile communication tester at least partly according to the configuration setting derived from the configuration message. In some embodiments, instructions and/or data are included in the configuration message based on which the mobile communication tester is configured.

According to one aspect, the at least one configuration message may relate, for example, to a 5G protocol using the ASN.1 format. The content of the at least one configuration message may be consolidated according to the corresponding protocol specification.

Embodiments of the method is thus particularly user-friendly and time-efficient, for example for users with knowledge of ASN.1. The user is merely required to input an ASN.1 message but the electronic circuit takes over the task of deriving appropriate consolidated settings for the mobile communication tester.

In some embodiments, consequences of the at least one configuration message are interpreted according to the protocol specification. The at least one configuration message may comprise a plurality of configuration messages having interrelated consequences. Consolidating the content of the at least one configuration message, for example, takes into account dependencies between the consequences, as defined in the protocol specification. Consolidating the content of the at least one configuration message can thus be seen as merging a plurality of configuration messages, resulting in one configuration setting. For example, at least two configuration messages may be merged, resulting in one configuration setting.

The at least one configuration message may relate to the 5G Radio Resource Control protocol. Hence, a user can influence fundamental settings of the tester via ASN.1. Settings pertaining to the 5G Radio Resource Control protocol may include, for example, connection establishment and release functions, broadcast of system information, as well as radio bearer establishment. In some embodiments, the corresponding protocol specification is 3GPP TS 38.331. For example, version 17.5.0 Release 17 may be used.

In some embodiments, the at least one configuration message may comprise a plurality of Radio Resource Control (RRC) messages, wherein the RRC messages are consolidated according to 5G Radio Resource Control protocol specification. The user can thus influence tester settings pertaining to the 5G Radio Resource Control protocol via ASN.1.

According to one aspect, the RRC messages consolidated according to 5G Radio Resource Control protocol specification concern, for example, user equipment. Hence, the consolidation of the RRC messages can be performed in a particularly efficient way. Merging RRC messages concerning the cell may be dispensed with, because the configuration of a cell can be fully described by one System Information Block Type 1 (SIB1). In some embodiments, importing multiple SIB1s for the same cell always builds the configuration from scratch.

In some embodiments, he at least one configuration message received by the electronic circuit is, for example, obtained from a user input. For example, the at least one configuration message is input via a client connected to an interface of the mobile communication tester. A high degree of flexibility regarding the device used for inputting the configuration message can thus be provided.

As an example, a user may input the control message via a web application. Alternatively, the configuration message may be input directly via a user interface of the mobile communication tester. A particularly simple and robust setup for inputting the configuration message can thus be provided.

Generally, the mobile communication tester can be, for example, a wireless network emulator, a radio frequency analyzer, or a conformance test system. The benefits of increased user-friendliness and improved time-efficiency can be achieved irrespective of the particular hardware used for testing the DUT.

According to another aspect, missing configuration settings of the mobile communication tester are automatically added, for example, by the mobile communication tester. Missing configuration settings are to be understood as required settings that are not present after the settings from the configuration message have been stored or implemented, e.g. runtime parameter MCS (modulation and coding scheme). Time and effort invested by the user can thus be reduced.

In some embodiments, the missing configuration settings are configuration settings not derived from messages formatted in ASN.1. These missing configuration settings cannot be derived from an ASN.1 message, for example because they are not provided using ASN.1 notation in a 5G protocol specification. Examples for such settings include runtime parameter modulation and coding scheme 1-16.

Standard settings may be used for the missing configuration settings. The automatic selection of standard settings may take into account the remaining settings, for example the settings derived from the received configuration message. However, missing configuration settings may also be added manually by a user.

The user may be informed about the automatically added configuration settings. Hence, the user is made aware of configuration settings that may require review. In some embodiments, the mobile communication tester posts a message with the information about the added settings via a publish-subscribe messaging pattern.

Further, the mobile communication tester may receive a user input and adapt the automatically added configuration settings based on the received user input. In some embodiments, the automatically added settings can be adapted according to e.g. the user's preferences or changing test requirements. Hence, embodiments of the method provides a high level of adjustability for the user, despite its automation features. As one example, the user may change to a different modulation and coding scheme (MCS) and run the test with the different MCS.

In some embodiments, the mobile communication tester can receive a user input and adapt further configuration settings based on the received user input, wherein the further configuration settings pertain to a different aspect than the configuration settings derived from the at least one configuration message received. Embodiments of the method thus allows handling different facets of the configuration in distinct ways.

According to another aspect, a user can also adapt, for example, configuration settings derived from a received configuration message. Flexibility and user-friendliness of the method can thus be further improved. For example, the user may change from band 1 (as configured according to a received configuration message) to band 2. if the user equipment does not support band 1.

In some embodiments, the configuration setting is stored in a database of the mobile communication tester. The database may comprise a class for user equipment settings and a class for cell settings. Effective storage and retrieval of the respective configuration settings can thus be enabled.

Properties of a DUT may be tested while the mobile communication tester is at least partly configured according to the at least one configuration message received. Accordingly, in contrast to known configuration methods, the method according to embodiments of the present disclosure enables a user to influence the implemented configuration of a mobile communication tester via an ASN.1 message.

The present disclosure further provides a mobile communication tester for testing a device under test. In an embodiment, the mobile communication tester comprises an electronic circuit configured (e.g., programmed, etc.) to receive at least one configuration message that is formatted (at least partially) in ASN.1; process the at least one configuration message formatted in ASN.1; and derive a configuration setting of the mobile communication tester at least partly from the at least one configuration message received.

Features and advantages described above with regard to the methods for configuring a mobile communication tester apply analogously to the mobile communication tester. In some embodiments, the mobile communication tester may be configured to implement steps and/or aspects of any of the example methods described above.

Generally, the mobile communication tester can be configured from perspective of user equipment (UE), namely the device under test, by using the at least one configuration message formatted in ASN.1.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a schematic view of a test setup including a mobile communication tester according to an embodiment of the present disclosure;

FIG. 2 is a flowchart illustrating a method for configuring a mobile communication tester according to an embodiment of the present disclosure; and

FIG. 3 is a functional diagram illustrating a method for configuring a mobile communication tester according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

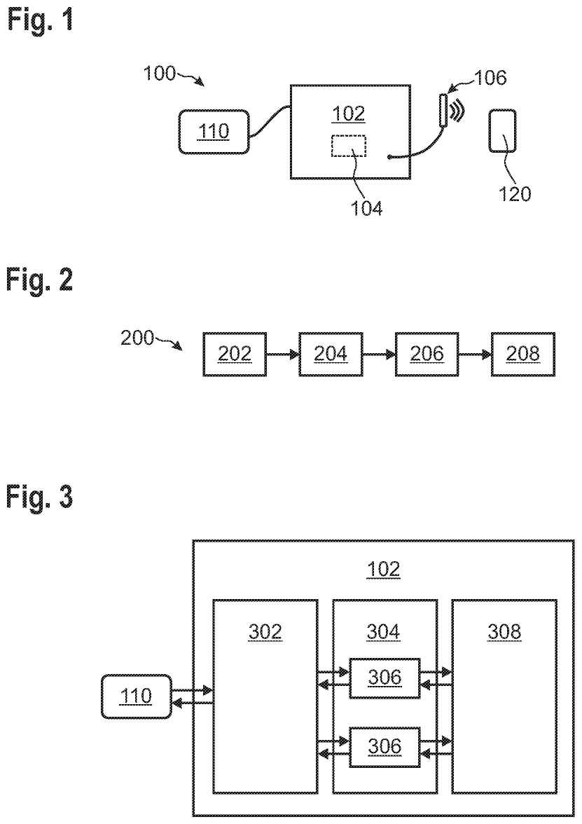

FIG. 1 is a schematic view of a test setup 100 including a mobile communication tester 102 according to an embodiment of the present disclosure. The test setup 100 may further comprise an antenna 106 connected to the mobile communication tester 102. The mobile communication tester 102 may be, for example, a wireless network emulator, a radio frequency analyzer, or a conformance test system.

In some embodiments, the mobile communication tester 102 comprises an electronic circuit 104 that is configured for testing a device under test 120. For example, the electronic circuit 104 is configured for testing signaling properties of the device under test 120. The device under test 120 may constitute a user equipment (UE), like for example a smartphone or a tablet.

In some embodiments, the electronic circuit 104 is configured for receiving at least one configuration message that is formatted in ASN.1. The at least one configuration message received by the electronic circuit 104 may be obtained from a user input.

For example, the at least one configuration message may be input via a client 110 connected to the mobile communication tester 102. The client 110 can be a general-purpose computer, a tablet or any other suitable electronic device. In some embodiments, the configuration message may be input directly via a user interface of the mobile communication tester 102.

In some embodiments, the electronic circuit 104 is further configured for processing the at least one configuration message formatted in ASN.1. Moreover, the electronic circuit 104 is configured for deriving a configuration setting of the mobile communication tester 102 at least partly from the at least one configuration message received. Hence, properties of the device under test 120 can be tested while the mobile communication tester 102 is at least partly configured according to the at least one configuration message received.

FIG. 2 is a flowchart illustrating a method 200 for configuring a mobile communication tester 102 according to an embodiment of the present disclosure. The method 200 comprises a step 202 of providing a mobile communication tester 102 with an electronic circuit 104 configured for testing a device under test 120. In some embodiments, the device under test 120 is via 5G New Radio.

The method 200 also comprises a step 204 of receiving, by the electronic circuit 104, at least one configuration message that is formatted in ASN.1. A message being formatted in ASN.1 may be understood as the message being written in the notation ASN.1. In addition, the method 200 comprises a step 206 of processing, by the electronic circuit 104, the at least one configuration message formatted in ASN.1.

In some embodiments, the method 200 further comprises a step 208 of deriving, by the electronic circuit 104, a configuration setting of the mobile communication tester 102 at least partly from the at least one configuration message received. Consequently, at least a part of the configuration of the mobile communication tester 102 may be based on the received configuration message.

Thus, users with knowledge of ASN.1 do not have to learn details about how the mobile communication tester 102 can be configured via an API or a graphical user interface (GUI) of the mobile communication tester 102. Instead, users can implement their existing knowledge of the notation ASN.1 and thus save time and effort.

In some embodiments, the at least one configuration message may relate to a 5G protocol using the ASN.1 format. In some embodiments, the content of the at least one configuration message is consolidated according to the corresponding protocol specification.

In some embodiments, consequences of the at least one configuration message are interpreted according to the protocol specification. The at least one configuration message may comprise a plurality of configuration messages having interrelated consequences. Consolidating the content of the at least one configuration message particularly takes into account dependencies between the consequences, as defined in the protocol specification. Consolidating the content of the at least one configuration message can thus be seen as merging a plurality of configuration messages, resulting in one configuration setting. For example, at least two configuration messages may be merged, resulting in one configuration setting.

For example, the at least one configuration message may relate to 5G Radio Resource Control protocol. In some embodiments, the corresponding protocol specification is 3GPP TS 38.331. For example, version 17.5.0 Release 17 may be used.

In some embodiments, the at least one configuration message may comprise a plurality of Radio Resource Control messages. The Radio Resource Control messages may be consolidated according to the 5G Radio Resource Control protocol specification.

As a specific example, the information element (IE) DMRS DownlinkConfig is referred to now. An IE is to be understood as a structural element of the protocol specification containing a single or multiple fields. The IE DMRS DownlinkConfig is used to configure downlink demodulation reference signals for the physical downlink shared channel (PDSCH).

The IE DMRS DownlinkConfig includes a field dmrs-AdditionalPosition which relates to position for additional demodulation reference signal (DM-RS) in downlink (cf. Tables 7.4.1.1.2-3 and 7.4.1.1.2-4 in 3GPP TS 38.211). According to the protocol specification, if the field dmrs-AdditionalPosition is absent, the user equipment sets this field to the value pos2.

Hence, some embodiments of the method 200 for configuring a mobile communication tester 102 may include setting the field dmrs-AdditionalPosition to the value pos2, in case the received ASN.1 configuration message does not include this field. Conversely, if a desired configuration is to set the field dmrs-AdditionalPosition to the value pos2, the user may purposefully omit this field in the configuration message. The settings of the mobile communication tester 102 can thus be configured in a particularly user-friendly and time-efficient way.

In some embodiments, the Radio Resource Control (RRC) messages may concern user equipment. Merging RRC messages concerning the cell may be dispensed with, because the configuration of a cell can be fully described by one System Information Block Type 1 (SIB1). In some embodiments, importing multiple SIB1s for the same cell always builds the configuration from scratch.

In some embodiments, the method 200 may further include automatically adding missing configuration settings of the mobile communication tester 102. Missing configuration settings are to be understood as required settings that are not present after the settings from the configuration message have been stored or implemented by the mobile communication tester 102.

In some embodiments, the missing configuration settings are not derived from messages formatted in ASN.1. In certain embodiments, the missing settings cannot be derived from an ASN.1 message, for example, because they are not provided using ASN.1 notation in a 5G protocol specification. Examples for such settings include runtime parameter modulation and coding scheme 1-16.

Standard settings may be used for the missing configuration settings. The automatic selection of standard settings may take into account the remaining settings, for example the settings derived from the received configuration message. However, missing configuration settings may also be added manually by a user.

The user may be informed about the automatically added configuration settings. In some embodiments, the mobile communication tester 102 posts a message with the information about the added settings via a publish-subscribe messaging pattern.

Further, the mobile communication tester 102 may receive a user input and adapt the automatically added configuration settings based on the received user input. In some embodiments, the automatically added settings can be adapted according to e.g. the user's preferences or changing test requirements. As one example, the user may change to a different modulation and coding scheme (MCS) and run the test with the different MCS.

In some embodiments, the mobile communication tester 102 can receive a user input and adapt further configuration settings based on the received user input, wherein the further configuration settings pertain to a different aspect than the configuration settings derived from the at least one configuration message received.

Referring now to FIG. 3, the configuration settings may be stored in a database 304 of the mobile communication tester 102. The database 304 may comprise a plurality of classes 306, for example a class for user equipment settings and a class for cell settings. The classes 306 may be interdependent.

Database entries of the cell-settings class, for example, comprise a list of all used cells. The main configuration of each individual cell can be expressed with ASN.1 System Information Blocks, for example System Information Block Type 1 (SIB1).

In some embodiments, fields regarding cell-specific configuration in SIB1 can be either mandatory or they can be optional and Need N (“No action”). Fields with Need N are not stored and their presence causes a one-time action by the user equipment. Upon receiving a message with the field absent, the user equipment takes no action.

Messages regarding the user equipment (UE), for example RRC setup and/or RRC reconfiguration messages, may be merged and imported into the database 304. Most UE-specific configurations are defined in the protocol specification as optional with need code Need M, Need S. or Need R and/or are SetupRelease information elements. ASN.1 RRC messages may be merged taking into account protocol specification 3GPP TS 38.331, for example Annex A.3 thereof (PDU specification). For merging, the messages are handled in the same sequence as they were recorded from a message log.

A client may interact with the database 304 via an application programming interface 302 of the mobile communication tester 102. In addition, an ASN.1 module 308 of the mobile communication tester 102 may allow interaction with the database 304 via ASN.1 messages. The ASN.1 module 308 can be, for example, a service or process running in the electronic circuit 104 of the mobile communication tester 102.

Certain embodiments disclosed herein include systems, apparatus, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry.” “circuit.” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured and/or purpose built circuits, machines, apparatus, devices, etc., capable of implemented the functionality described herein.

Of course, in some embodiments, two or more of these components, or parts thereof, can be integrated or share hardware and/or software, circuitry, etc. In some embodiments, these components, or parts thereof, may be grouped in a single location or distributed over a wide area. In circumstances where the components are distributed, the components are accessible to each other via communication links.

In some embodiments, one or more of the components referenced above, such as the electronic circuit 104, include circuitry programmed to carry out one or more steps of any of the methods disclosed herein. In some embodiments, one or more computer-readable media associated with or accessible by such circuitry contains computer readable instructions embodied thereon that, when executed by such circuitry, cause the component or circuity to perform one or more steps of any of the methods disclosed herein.

In some embodiments, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In some embodiments, computer-readable media is any medium that stores computer readable instructions, or other information non-transitorily and is directly or indirectly accessible to a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In some embodiments, memory can be integrated with a processor, separate from a processor, or external to a computing system.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting. even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method for configuring a mobile communication tester, the method comprising the steps of:
providing a mobile communication tester with an electronic circuit configured for testing a device under test;
receiving, by the electronic circuit, at least one configuration message that is formatted at least partially in ASN.1;
processing, by the electronic circuit, the at least one configuration message formatted in ASN.1; and
deriving, by the electronic circuit, a configuration setting of the mobile communication tester at least partly from the at least one configuration message received.

2. The method according to claim 1, wherein the at least one configuration message relates to a 5G protocol using the ASN.1 format, and wherein the content of the at least one configuration message is consolidated according to the corresponding protocol specification.

3. The method according to claim 2, wherein the at least one configuration message relates to 5G Radio Resource Control protocol.

4. The method according to claim 1, wherein the at least one configuration message comprises a plurality of Radio Resource Control messages and wherein the Radio Resource Control messages are consolidated according to 5G Radio Resource Control protocol specification.

5. The method according to claim 4, wherein the Radio Resource Control messages concern user equipment.

6. The method according to claim 1, wherein the at least one configuration message received by the electronic circuit is obtained from a user input.

7. The method according to claim 6, wherein the at least one configuration message is input via a client connected to an interface of the mobile communication tester.

8. The method according to claim 1, wherein the mobile communication tester is a wireless network emulator, a radio frequency analyzer, or a conformance test system.

9. The method according to claim 1, wherein missing configuration settings of the mobile communication tester are automatically added.

10. The method according to claim 9, wherein the missing configuration settings are not derived from messages formatted in ASN.1.

11. The method according to claim 9, wherein the user is informed about the automatically added configuration settings.

12. The method according to claim 9, wherein the mobile communication tester receives a user input and adapts the automatically added configuration settings based on the received user input.

13. The method according to claim 1, wherein the mobile communication tester receives a user input and adapts further configuration settings based on the received user input, wherein the further configuration settings pertain to a different aspect than the configuration settings derived from the at least one configuration message received.

14. The method according to claim 1, wherein the configuration setting is stored in a database of the mobile communication tester.

15. The method according to claim 14, wherein the database comprises a class for user equipment settings and a class for cell settings.

16. The method according to claim 1, wherein properties of a device under test are tested while the mobile communication tester is at least partly configured according to the at least one configuration message received.

17. A mobile communication tester for testing a device under test, wherein the mobile communication tester comprises an electronic circuit configured to:
receive at least one configuration message that is formatted at least partially in ASN.1;
process the at least one configuration message formatted in ASN.1; and
derive a configuration setting of the mobile communication tester at least partly from the at least one configuration message received.
